(19) United States
(12) Patent Application Publication
(10) Pub. No.: US 2026/0181536 A1
(43) Pub. Date: Jun. 25, 2026

(54) SYSTEMS AND METHODS FOR CLASSIFYING AN ACCESS POINT (AP) IN A WIRELESS FIDELITY (WI-FI) SYSTEM

(71) Applicant: Samsung Electronics Co., Ltd., Suwon-si (KR)

(72) Inventors: Mayank Kumar SAHU, Bangalore (IN); Jayendra Reddy KOVVURI, Bangalore (IN); Madhan Raj KANAGARATHINAM, Bangalore (IN); Ritik KUMAR, Bangalore (IN); Srihari SRIRAM, Bangalore (IN); Raj Kumar SARANAPPA, Bangalore Karnataka (IN); Farooq Hussain SAHABZAD, Bangalore Karnataka (IN)

(21) Appl. No.: 19/438,054

(22) Filed: Dec. 31, 2025

Related U.S. Application Data
(63) Continuation of application No. PCT/KR2025/022227, filed on Dec. 18, 2025.

(30) Foreign Application Priority Data
Dec. 19, 2024 (IN) 2024 41100920
Oct. 9, 2025 (IN) 202441100920

(51) Int. Cl. H04W 48/16; H04B 17/318; H04B 17/336; H04W 84/12

(52) U.S. Cl. CPC H04W 48/16; H04B 17/318; H04B 17/336; H04W 84/12

(57) ABSTRACT

A system and a method for classifying an access point (AP) in a wireless fidelity (Wi-Fi) system are disclosed. The method includes: receiving, by a station, at least one signal parameter associated with the Wi-Fi system by performing a signal scanning of at least one available AP in an area of the station; processing the received at least one signal parameter and a sensor information; and determining a mobility status of the at least one available AP in the area of the station, wherein the mobility status is determined by classifying the at least one available AP as at least one of: a static AP and a non-static AP based on an analysis of the received at least one signal parameter, the sensor information, and historical data using at least one data driven model.

### CROSS REFERENCE TO RELATED APPLICATIONS

This application is a continuation of International Application No. PCT/KR2025/022227 designating the United States, filed on Dec. 18, 2025, in the Korean Intellectual Property Receiving Office and claiming priority to Indian Provisional Patent Application No. 202441100920, filed on Dec. 19, 2024, and Indian Complete patent application No. 202441100920, filed on Oct. 9, 2025, in the Indian Patent Office, the disclosures of each of which are incorporated by reference herein in their entireties.

### BACKGROUND

### Field

The disclosure relates to the field of wireless communication, and for example, to systems and methods for classifying an access point (AP) in a wireless fidelity (Wi-Fi) system.

### Description of Related Art

Generally, a wireless fidelity (Wi-Fi) Received Signal Strength Indicator (RSSI) fingerprint-based localization is a widely used technique for determining the position of a device within an environment. The localization is achieved using various technologies including a global positioning system (GPS), a Wi-Fi, a Bluetooth (BT), Cellular signals, a radio frequency identification (RFID), alight detection and ranging (LiDAR), and a computer vision.

The Wi-Fi system has a station (STA) that connects to a Wi-Fi access point to access data related services. The access points (AP) may be a static AP, that is fixed at one place and a dynamic AP or a non-static AP, that may move around, for example a mobile hotspot. The localization can be used in applications, such as, but not limited to, a navigation, an asset tracking, a search and rescue operation, autonomous vehicles, and so on. However, On Device localization has its own challenges, such as:
a) A dynamic nature of access points (APs): Unlike static APs, the locations of non-static APs frequently change, leading to inconsistent RSSI patterns that distort the fingerprint dataset.
b) Signal Instability: Certain APs often emit weaker and less stable signals compared to the static APs, further degrading the quality of the RSSI fingerprint.
c) Environmental Interference: The presence of few APs may amplify multipath effects and interference, resulting in skewed RSSI readings.
d) Data Overhead: Including multiple AP data increases the computational complexity for fingerprint matching and model training, potentially slowing down the localization process.
e) Reduced Scalability: Environments with high mobility face challenges in maintaining reliable and up-to-date fingerprint databases.
f) Power Constraints: Unlike AP, the STA is power limited, which can hamper power utilization.
g) To achieve accurate Wi-Fi RSSI fingerprint-based localization, it is necessary to identify and filter out interested data set in a power efficient manner.

The localization can be performed outdoors, which can be primarily reliant on satellite-based Global Navigation Satellite Systems (GNSS), such as GPS, GLONASS and Galileo, and uses signals from multiple satellites to triangulate a receiver's position on Earth's surface. GNSS has an accuracy of 5 meters under open skies, good enough for outdoor localization applications. However, the accuracy degrades inside buildings, near trees etc. when there is no line of sight.

Instead of precise geographic coordinates, localization systems can assign meaningful labels such as “Home”, “Office”, or “Gym”, reflecting the user's frequently visited places. A blend of geofencing, pattern recognition, and contextual sensing (e.g., Wi-Fi fingerprints, mobile sensors), are used to achieve this.

The localization can be performed indoors, which can involve pinpointing the position of people or objects within enclosed environments, such as offices, shopping malls, airports, or warehouses. Currently, most people spend approximately 80% of their daily lives indoors. As a result, approximately 70% of smartphone usage and 80% of data transmission occur in indoor environments. Hence, a ubiquitous solution for indoor localization is important. There are a diverse set of technologies that can be used for indoor localization, such as wireless localization, vision-based localization, and other techniques (such as, but not limited to, acoustic background fingerprinting, the dead-reckon method, magnetic Fields, accelerometers, barometers, and so on). In wireless localization, wireless signal-based techniques use various measurement parameters, such as a time of arrival (ToA), a time of Fight (ToF), an angle of arrival (AoA), a time difference of Flight (TDoF), a time difference of arrival (TDoA), a received signal strength indicator (RSSI), and a channel state information (CSI). The underlying wireless protocol can be anything from the Wi-Fi, the BT to ultra-wide band (UWB). In vision-based localization, computer vision techniques, use multiple devices, such as monochrome cameras and infrared cameras, to capture visual information and apply computational processing techniques to estimate the locations of users.

Types of Wireless localization techniques can include geometric approaches, fingerprinting approaches, standards ranging protocols, the CSI fingerprinting, the RSSI fingerprinting, a hybrid approach including RSSI and CSI fingerprinting, and so on. Geometric approaches include multiliterate, trilateration, and triangulation methods, for which various measurement parameters (ToA, ToF, AoA, etc.) can be used, and the relative positions of anchors is known before hand, wherein the final position will be calculated relative to the anchors. Geometric approaches can work in real-time with minimal pre-processing once the infrastructure is set. However, signal reflections, multipath effects, and obstacles can degrade performance.

The fingerprinting approaches employ the RSSI or the CSI as a pattern matching parameter to determine the positions of devices, which can be more robust in complex indoor environments where geometric methods struggle.

The standard ranging protocols are designed for estimation of distance between two devices using the radio technology. Considering the example of Wi-Fi-802.11mc 802.11az, these standards use a technique called “Fine Time Measurement (FTM)” to calculate distances between Wi-Fi devices based on the time taken for a signal to travel between the Wi-Fi devices. While 802.11mc provides basic location information, 802.11az offers significantly higher accuracy, allowing for more precise positioning with sub-meter precision in ideal conditions. This is achieved by utilizing enhanced features like wider channel bandwidth and MIMO signal properties for better distance estimation. However, the penetration of the AP which support these protocols is very low. Also, there is no information about angle, hence multiple APs are needed.

In another example, a BT 6.0—Bluetooth Channel Sounding, an initiator sends signals to a reflector device repeatedly across multiple frequencies. The distance is calculated by comparing phase differences between transmitted and received signals over these frequencies.

The CSI fingerprinting involves capturing detailed wireless channel characteristics (amplitude, phase, delay) and reflects environmental, enabling non-contact sensing of both large and subtle movements. The sensitivity allows the CSI to support diverse applications, including smart environment monitoring, human activity recognition, and precise wireless positioning. The CSI based localization is less sensitive to small environmental changes due to richer signal properties. However, the CSI fingerprinting requires specialized tools and more computational resources to extract and interpret the CSI data. Not all Wi-Fi devices provide easy access to the CSI information and it is difficult to obtain in the station. Although not easy to implement, if the application requires precise localization, the CSI fingerprinting is the best wireless solution.

The RSSI is an easily available metric and is used by multiple wireless protocols, which involves using the RSSI from stationary BT devices. The BT devices (which are typically stationary devices, such as, but not limited to televisions, and so ono) broadcast the device type. But the issue was, the RSSI vs distance curve is mostly flat for Bluetooth. Hence localization using BT RSSI is difficult. Wi-Fi RSSI on the other hand is more reliable as the slope of the curve is higher.

FIG. 1 is a diagram illustrating an example scenario of indoor localization, according to existing art. In an example, for indoor localization of a mobile device 101, the device may scan for nearby access points. The mobile device 101 may also scan soft access points (Soft APs) or non-static APs in a coverage area of the mobile device 101. During localizing the same mobile device 101 for a second time, the soft access points may be absent. Due to inconsistency in the availability of the non-static APs, the localization is prone to errors. With the increasing demand for indoor localization and the growing use of the non-static APs in modern Wi-Fi networks, the accuracy of location-based services has become a significant challenge. As more devices utilize the non-static APs to provide Wi-Fi connectivity, various issues arise, such as inconsistent signal strength, dynamic device configurations, and frequent changes in the network setup. These factors contribute to errors in Wi-Fi fingerprinting systems, highlighting the need for improved methods to maintain accurate localization and optimize positioning in dynamic environments.

FIG. 2 is a diagram 200 illustrating an example of factors affecting indoor localization due to soft AP characteristics, according to the existing art. The first factor affecting the indoor localization may be a dynamic nature of soft Aps. The non-static APs are often turned on and off or moved within the environment, making their presence and locations less stable. The dynamic behavior leads to missing or inconsistent RSSI data in the Wi-Fi fingerprinting database, which affects the system's ability to accurately identify a device's location based on signal strength. The second factor affecting the indoor localization may be an incorrect positioning of the non-static APs. The position of the non-static APs in the fingerprint database may not always match their actual physical location. When the non-static APs are misplaced in the database, their RSSI values are misinterpreted, leading to incorrect localization and errors in determining a device's true position, thus reducing the overall accuracy of the system. The third factor affecting the indoor localization may be a signal instability. The signal strength from soft APs can vary significantly due to hardware differences, environmental interference, and adjustable power settings. This variability causes inconsistent RSSI readings, which disrupts the system's ability to match observed values with pre-recorded fingerprints, resulting in less reliable location estimates. The fourth factor affecting the indoor localization may be a difficulties in maintaining database. The soft APs are frequently moved or reconfigured, making it challenging to maintain an accurate and up-to-date fingerprint database. Without regular updates, the database becomes outdated, which compromises the accuracy of location tracking over time and can lead to significant errors in positioning.

Hence, there is a need in the art to address the above-mentioned drawback(s), among others.

### SUMMARY

Embodiments of the disclosure provide systems and methods for classifying an access point (AP) in a wireless fidelity (Wi-Fi) system.

Embodiments of the disclosure disclose receiving at least one signal parameter associated with the Wi-Fi system by a station by performing a signal scanning of at least one available access point (AP) in an area of the station.

Embodiments of the disclosure disclose pre-processing of the received at least one signal parameter and sensor information.

Embodiments of the disclosure disclose determining, by the station, a mobility status of the AP by the station in the area of the station, by classifying the at least one AP as at least one of: a static AP and a non-static AP based on an analysis of the received at least one signal parameter, the sensor information, and a historical data using the at least one data driven model.

Embodiments of the disclosure disclose storing the identified non-static AP in a database.

Embodiments of the disclosure disclose maintaining the database of the identified non-static AP for future use.

Embodiments of the disclosure disclose storing a Received Signal Strength Indicator (RSSI) for the AP identified as the static AP in a Wi-Fi fingerprinting dataset.

Embodiments of the disclosure disclose excluding the RSSI for the AP identified as non-static AP from the Wi-Fi fingerprinting dataset.

Embodiments of the disclosure disclose determining a spatial context of the station with better accuracy of a location of the station by performing a localization based on the Wi-Fi fingerprinting dataset using at least one machine learning model.

Embodiments of the disclosure disclose receiving a request by the AP to generate a neighbor report from the station.

Embodiments of the disclosure disclose performing a signal scanning by the AP of at least one available AP in an area of the station.

Embodiments of the disclosure disclose receiving at least one signal parameter of the Wi-Fi system by the AP by performing the signal scanning of at least one available AP in an area of the station.

Embodiments of the disclosure disclose pre-processing the received at least one signal parameter and a sensor information by the AP.

Embodiments of the disclosure disclose identifying whether the at least one Wi-Fi AP is at least one of: a static AP and a non-static AP by the AP based on an analysis of the received at least one signal parameter, the sensor information, and a historical data using the at least one data driven model.

Embodiments of the disclosure disclose generating the neighbor report by embedding a one-bit mobility indicator, by the AP, allowing the AP to inform the station whether the at least one AP is at least one of: a static AP and a non-static AP.

According to an example embodiment, a method for classifying an access point (AP) in a wireless fidelity (Wi-Fi) system is provided. The method includes: receiving, by a station, at least one signal parameter associated with the Wi-Fi system by performing a signal scanning of at least one available AP in an area of the station; pre-processing, by the station, the received at least one signal parameter and sensor information; and determining, by the station, a mobility status of the at least one available AP in the area of the station, wherein the mobility status is determined by classifying the at least one available AP as at least one of: a static AP and a non-static AP based on an analysis of the received at least one signal parameter, the sensor information, and historical data using at least one data driven model.

According to an example embodiment, a method for classifying an AP in a wireless fidelity (Wi-Fi) system is provided. The method includes: receiving, by an AP, at least one signal parameter of the Wi-Fi system by performing a signal scanning of at least one available AP in an area of a station; pre-processing, by the AP, the received at least one signal parameter and a sensor information; identifying, by the AP, whether the at least one available AP is at least one of: a static AP and a non-static AP based on an analysis of the received at least one signal parameter, the sensor information, and historical data using at least one data driven model; and generating, by the AP, a neighbor report including a mobility indicator, the mobility indicator including information to inform the station whether the at least one available AP is at least one of: a static AP and a non-static AP.

According to an example embodiment a station in a wireless fidelity (Wi-Fi) system is provided. The station includes: at least one processor, comprising processing circuitry, individually and/or collectively, configured to execute at least one data driven model, memory, a data driven model-based access point (AP) classifying controller, comprising circuitry, coupled with at least one processor and the memory, wherein the data driven model-based AP classifying controller is configured to cause the station to: receive at least one signal parameter of the Wi-Fi system, by performing a signal scanning of at least one available AP in an area of the station; pre-process the received at least one signal parameter and sensor information; and determine a mobility status of the at least one available AP in the area of the station, wherein the mobility status is determined by classifying the at least one available AP as at least one of: a static AP and a non-static AP based on an analysis of the received at least one signal parameter, the sensor information, and historical data using the at least one data driven model.

According to an example embodiment, an access point (AP) in a wireless fidelity (Wi-Fi) system, comprising at least one processor, comprising processing circuitry, individually and/or collectively, configured to execute at least one data driven model, memory, and a data driven model-based AP classifying controller, comprising circuitry, coupled with at least one processor and the memory, the data driven model-based AP classifying controller being configured to cause the AP to: receive at least one signal parameter of the Wi-Fi system by performing a signal scanning of at least one available AP in an area of a station; pre-process the received at least one signal parameter and sensor information; identify whether the at least one available AP is at least one of: a static AP and a non-static AP based on an analysis of the received at least one signal parameter, the sensor information, and historical data using the at least one data driven model; and generate a neighbor report including a mobility indicator, the mobility indicator including information to inform the station whether the at least one AP is at least one of: a static AP and a non-static AP.

These and other aspects of the disclosure will be better appreciated and understood when considered in conjunction with the following description and the accompanying drawings. It should be understood, however, that the following descriptions, while indicating various example embodiments and numerous specific details thereof, are given by way of illustration and not of limitation. Many changes and modifications may be made within the scope of the disclosure without departing from the spirit thereof, and the example embodiments herein include all such modifications.

### BRIEF DESCRIPTION OF THE DRAWINGS

Various example embodiments of the disclosure are illustrated in the accompanying drawings, throughout which like reference letters indicate corresponding parts in the various figures. Further, the above and other aspects, features and advantages of certain embodiments of the present disclosure will be more apparent from the following detailed description, taken in conjunction with the accompanying drawings, in which:

FIG. 1 is a diagram illustrating an example scenario of indoor localization, according to the existing art;

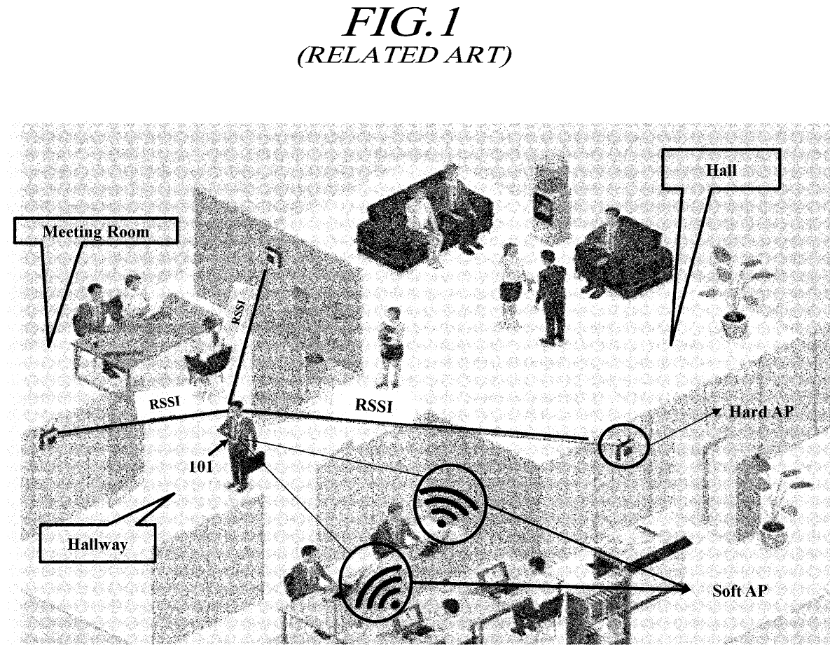

FIG. 2 is a diagram illustrating an example of factors affecting indoor localization due to soft AP characteristics, according to the existing art;

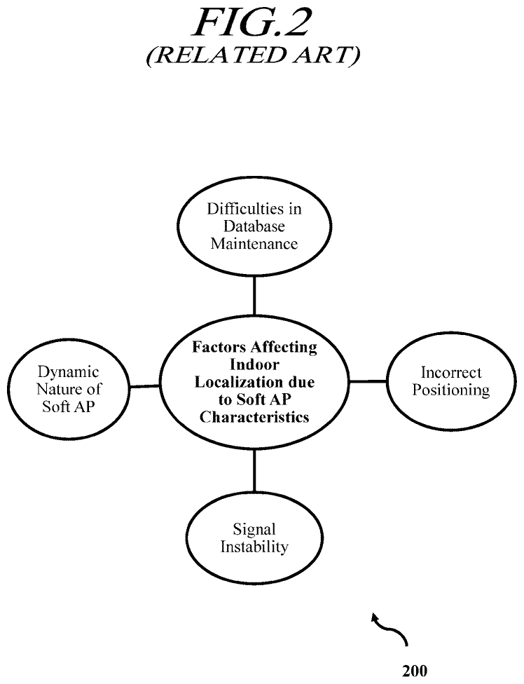

FIG. 3 is a diagram illustrating an example wireless fidelity (Wi-Fi) system for wireless communication, according to various embodiments;

FIG. 4 is a diagram illustrating example scenarios showing the mobility between the AP and the station, according to various embodiments;

FIG. 5 is a block diagram illustrating an example configuration of the station, according to various embodiments;

FIG. 6 is a flow diagram illustrating example operations for detection of the non-static AP using the at least one data driven model, according to various embodiments;

FIG. 7 is a flow diagram illustrating example operations for classifying of the static AP and the non-static AP in the WI-FI RSSI based localization, according to various embodiments;

FIG. 8 is a flowchart illustrating an example method for optimizing Wi-Fi RSSI fingerprint database with Static and Non-static AP classification according to various embodiments;

FIG. 9 is a flowchart illustrating an example method for using a pre-saved mobility status information to determine the mobility status of the AP, according to various embodiments;

FIG. 10 is a flowchart illustrating an example process of separating a new location from an existing location, according various embodiments;

FIG. 11 is a flowchart illustrating example operations for training the data driven model, according to various embodiments;

FIG. 12 is a block diagram illustrating an example configuration of the access point, according to various embodiments;

FIG. 13 is a table illustrating embedding of the one-bit mobility indicator, according to various embodiments as disclosed herein; and

FIG. 14 is a flowchart illustrating an example method for classifying access point (AP), according to various embodiments as disclosed herein.

### DETAILED DESCRIPTION

The various example embodiments herein and the various features and advantageous details thereof are explained more fully with reference to non-limiting embodiments illustrated in the accompanying drawings and detailed in the following description. Descriptions of well-known components and processing techniques may be omitted so as to not unnecessarily obscure the embodiments herein. The examples used herein are intended merely to facilitate an understanding of ways in which the disclosure may be practiced an. Accordingly, the examples should not be understood as limiting the scope of the disclosure.

For the purposes of interpreting this disclosure, the definitions (as defined herein) will apply and whenever appropriate the terms used in singular will also include the plural and vice versa. It is to be understood that the terminology used herein is for the purposes of describing example embodiments and is not intended to be limiting. The terms “comprising”, “having” and “including” are to be understood as open-ended terms unless otherwise noted.

The words/phrases “exemplary”, “example”, “illustration”, “in an instance”, “and the like”, “and so on”, “etc.”, “etcetera”, “e.g.,”, “i.e.,” are merely used herein to refer to “serving as an example, instance, or illustration.” Any embodiment or implementation of the present disclosure described herein using the words/phrases “exemplary”, “example”, “illustration”, “in an instance”, “and the like”, “and so on”, “etc.”, “etcetera”, “e.g.,”, “i.e.,” is not necessarily to be construed as preferred or advantageous over other embodiments.

Embodiments herein may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by a firmware. The circuits may, for example, be embodied in one or more semiconductor chips, or on substrate supports such as printed circuit boards and the like. The circuits of a block may be implemented by dedicated hardware, or by a processor (e.g., one or more programmed microprocessors and associated circuitry), or by a combination of dedicated hardware to perform some functions of the block and a processor to perform other functions of the block. Each block of the various embodiments may be physically separated into two or more interacting and discrete blocks without departing from the scope of the disclosure. Likewise, the blocks of the various embodiments may be physically combined into more complex blocks without departing from the scope of the disclosure.

It should be noted that elements in the drawings are illustrated for the purposes of this description and ease of understanding and may not have necessarily been drawn to scale. For example, the flowcharts/sequence diagrams illustrate the method in terms of the steps required for understanding of aspects of the various embodiments as disclosed herein. Furthermore, in terms of the construction of the device, one or more components of the device may have been represented in the drawings by conventional symbols, and the drawings may show only those specific details that are pertinent to understanding the various embodiments so as not to obscure the drawings with details that will be readily apparent to those of ordinary skill in the art having the benefit of the description herein. Furthermore, in terms of the system, one or more components/modules which comprise the system may have been represented in the drawings by conventional symbols, and the drawings may show specific details that are pertinent to understanding the present embodiments so as not to obscure the drawings with details that will be readily apparent to those of ordinary skill in the art having the benefit of the description herein.

The accompanying drawings are used to help easily understand various technical features and it should be understood that the various embodiments presented herein are not limited by the accompanying drawings. As such, the various embodiments herein should be construed to extend to any modifications, equivalents, and substitutes in addition to those which are particularly set out in the accompanying drawings and the corresponding description. Usage of words such as first, second, third etc., to describe components/elements/steps is for the purposes of this description and should not be construed as sequential ordering/placement/occurrence unless specified otherwise.

Various example embodiments herein disclose a system and a method for classifying an access point (AP) in a wireless fidelity (Wi-Fi) system. The various embodiments herein intelligently detect whether a Wi-Fi access point is a mobile hotspot (Soft AP) or a fixed infrastructure AP using signal characteristics such as a received signal strength indicator (RSSI), a signal-to-noise ratio (SNR), a vendor element, and a channel state information (CSI) combined with machine learning. The classification of the AP enhances Wi-Fi client behavior by improving network selection, roaming stability, and location accuracy. The identified non-static APs are excluded from fingerprinting databases and can be deprioritized in scan results, enhancing user experience and system reliability. The classification can be integrated into the 802.11k neighborhood report to enable standardized mobility awareness across Wi-Fi networks.

The various example embodiments herein disclose machine learning based AP mobility classification. A machine learning model trained on real-world signal features (e.g., RSSI, SNR, CSI) under different movement scenarios to accurately distinguish between non-static APs and static APs. The AP classification may be done for Wi-Fi Fingerprinting. The identified non-static APs are excluded from Wi-Fi fingerprint databases to prevent/reduce errors in indoor localization systems caused by unstable or moving networks. The AP classification may also be done on the AP side and 802.11k Wi-Fi standard enhancement. The 802.11k neighborhood report protocol may be extended by embedding a one-bit mobility indicator, allowing infrastructure APs to inform clients whether nearby APs are mobile (non-static) or static. A decision engine may use an AP mobility status to guide ranking in scan lists, secure connection policies, roaming preferences, and a multi-link (MLO) band.

The various example embodiments herein may use real-time, machine learning-driven ability to accurately classify Wi-Fi access points as mobile (non-static APs) or fixed (static APs), combined with its integration into the existing Wi-Fi protocols (like 802.11k) to communicate this classification to client devices. The various example embodiments herein enable the Wi-Fi clients and networks to dynamically adapt behaviors such as optimizing a network selection, a roaming network, a multi-link management, and a security policy based on the AP mobility status. Such an integrated, intelligent system for AP mobility awareness is unprecedented and addresses long-standing challenges in Wi-Fi localization accuracy, connection stability, and efficient network management, marking a significant advancement over traditional Wi-Fi systems that treat all APs equally. The standardization feature can improve interoperability across vendors, optimize handover strategies, enhance indoor positioning accuracy, and boost user experience in heterogeneous wireless environments.

The various example embodiments herein may enhance the accuracy of Wi-Fi-based location apps like maps, delivery tracking, or smart home geofencing by excluding the non-static APs from the fingerprint database. The various example embodiments herein may prevent/block users from unknowingly connecting to mobile hotspots and the non-static APs that frequently move or disconnect, ensuring a more stable internet experience. The various embodiments herein improve handover decisions by avoiding transitions to mobile hotspots, reducing connection drops and delays during movement e.g., walking in buildings or commuting. The various embodiments herein provide helpful tips and context-aware warnings (e.g., “You are connected to a mobile hotspot expect slower speeds or data limits”), improving user awareness and experience. The various embodiments herein provide accurate AP classification using machine learning. Embodiments herein address the problem of distinguishing the non-static APs vs. the static APs using signal-level data. The various embodiments herein disclose fingerprint database integrity. The various embodiments herein may remove unreliable mobile APs (the non-static APs) from location databases to improve indoor positioning precision. The various embodiments herein may extend 802.11k protocol to share AP mobility information, bridging a gap in current Wi-Fi specification. The various embodiments herein enable adaptive roaming and MLO optimization. The various embodiments herein enable smarter client behavior by avoiding association with moving hotspots. The various embodiments herein introduce context-aware network behavior. The various embodiments herein align the Wi-Fi systems with next-gen networking needs.

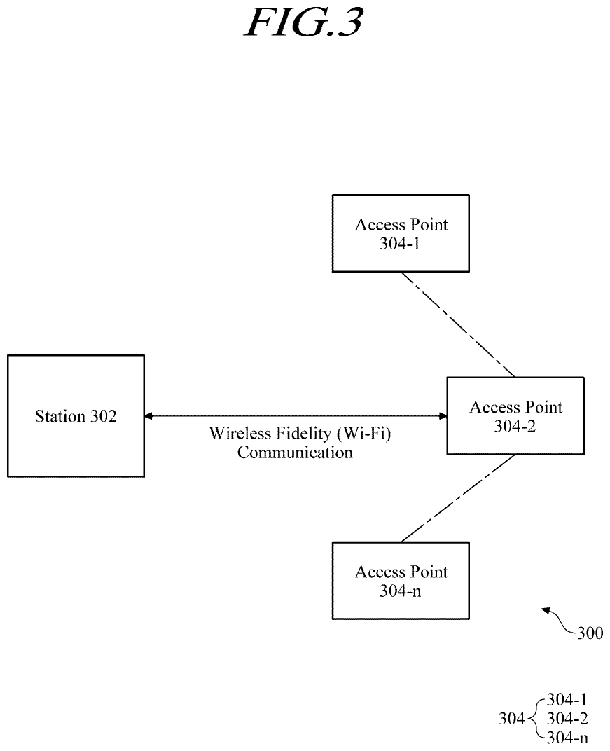

The various example embodiments herein achieve a systems and methods for classifying an access point (AP) in a Wi-Fi system. Referring now to the drawings, and more particularly to FIGS. 3 through 14, where similar reference characters denote corresponding features consistently throughout the figures, there are shown various example embodiments.

FIG. 3 is a diagram illustrating an overview of a Wi-Fi system 300 for wireless communication, according to various embodiments. Schematically, the Wi-Fi system 300 includes a station 302 and an AP(s) 304. There may be multiple APs (304-1, 304-2 to 304-n) available in the coverage area of the station 302. The station 302 may connect to only one AP 304 at a time. The station 302 may refer, for example, to a device that has access to the Wi-Fi and allows transmission and reception of data. The station 302 may include but is not limited to a non-AP station. The station 302 may be, for example, but not limited to a laptop, a smart phone, a desktop computer, a notebook, a Device-to-Device (D2D) device, a vehicle to everything (V2X) device, a foldable phone, a smart TV, a tablet, a television, a connected car, an immersive device, an internet of things (IoT) device, or any other device that can communicate using the wireless network. The AP 304 is a Wi-Fi access point. The AP 304 is used to connect a wired network to a wireless network. The AP 304 is connected to a router by a wired connection and transmits a Wi-Fi signal to connect other wireless devices (the station 302). The router may use interfaces such as, but not limited to, HTTPS, MQTT, FTP, cellular networks, NB-IoT, LoRa WAN, Wi-Fi, Bluetooth, BLE, satellite networks, and so on to provide wireless communication network to the AP 304. The AP 394 may be a static AP and a no-static AP. The static AP is a Wi-Fi AP with a fixed configuration that does not change automatically. The static AP typically uses a manual IP address (not assigned by DHCP) and fixed channel/SSID settings. The static APs provide consistent network parameters, useful for stable enterprise or industrial setups. A non-static AP is a Wi-Fi AP with settings that can change automatically or be assigned dynamically. The non-static AP may include a mobile hotspot, that may have a mobility status that is it can move around, and the mobile hotspots may be turned-on and off according to a requirement of a user.

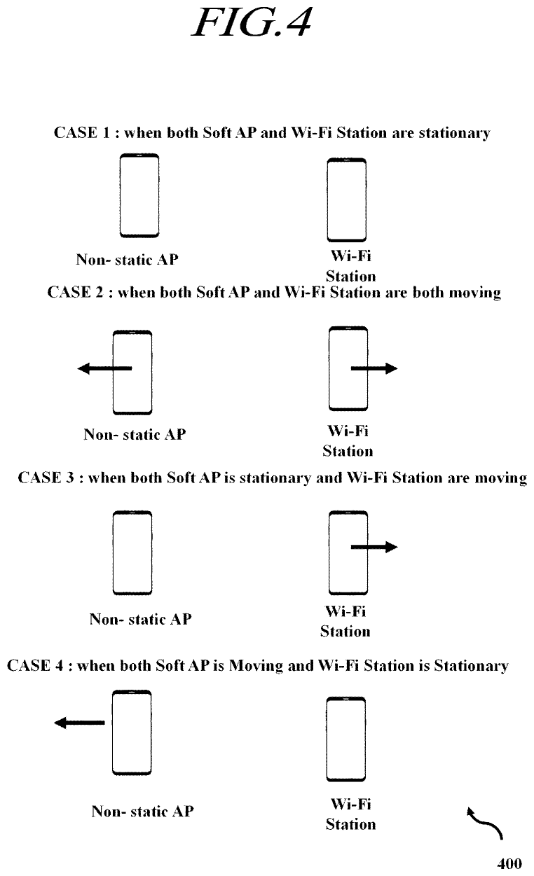

FIG. 4 is a diagram 400 illustrating example scenarios showing the mobility between the AP 304 and the station, according to various embodiments. The mobile hotspots or the non-static AP 304 are also called soft APs. As shown in case 1, the non-static AP 304 and the station 302 are not moving and are stationary. In case 2, the non-static AP 304 and the station 302 may be moving with respect to each other. In case 3, the non-static AP 304 may stationary, and the station 302 is moving. In case 4, the station 302 may be stationary, and the non-static AP may be moving. A data driven model in the AP and the station may be pre-trained to detect the case 1 to case 4, The pre-trained data driven model is used to infer the case 4 (as describe above) to detect whether connected the Wi-Fi is at least one of the static AP or the non-static AP.

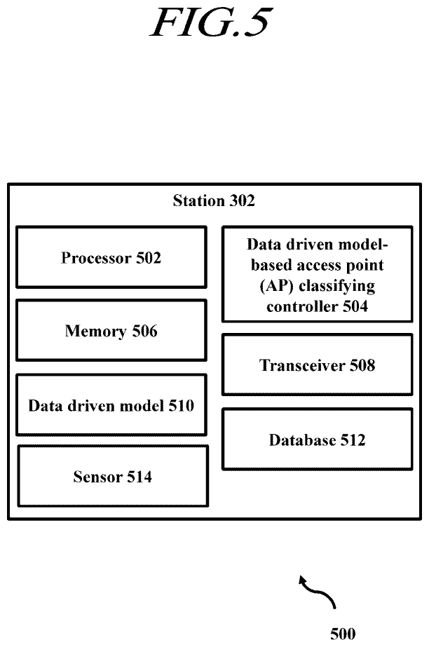

FIG. 5 is a block diagram 500 illustrating an example configuration of the station 302, according to various embodiments. The station 302 includes a processor (e.g., including processing circuitry) 502, a data driven model-based AP classifying controller (e.g., including circuitry) 504, a memory 506, a transceiver 508, a data driven model (e.g., including circuitry and/or executable program instructions) 510, a database 512 and a sensor 514.

The processor 502, the data driven model-based AP classifying controller 504, the memory 506, the transceiver 508, the data driven model 510, and the database 512 communicate with each other.

The processor 502 may include various processing circuitry, including one or a plurality of processors. The one or the plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor 502 may include multiple cores and is configured to execute the instructions stored in the memory 506. Thus, each “processor” 502 (e.g., including the controller 504) or “model” 510 herein may include processing circuitry, and/or may include multiple processors. For example, as used herein, including the claims, the term “processor” or “model” may include various processing circuitry, including at least one processor, wherein one or more of at least one processor, individually and/or collectively in a distributed manner, may be configured to perform various functions described herein. As used herein, when “a processor,” “at least one processor,” “a model,” “at least one model,” and “one or more processors” are described as being configured to perform numerous functions, these terms cover various situations, for example and without limitation, in which one processor and/or model performs some of recited functions and another processor(s) and/or model(s) performs other of recited functions, and also situations in which a single processor and/or model may perform all recited functions. Additionally, the at least one processor may include a combination of processors performing various of the recited/disclosed functions, e.g., in a distributed manner. At least one processor may execute program instructions to achieve or perform various functions. Likewise, the at least one model may include a combination of circuitry and/or processors performing various of the recited/disclosed functions, e.g., in a distributed manner. At least one processor and/or model may execute program instructions to achieve or perform various functions.

In an embodiment herein, the processor 502 is configured to execute instructions stored in the memory 506 and to perform various processes. The transceiver 508 is configured for communicating internally between internal hardware components and with external devices via one or more networks. In an embodiment, the transceiver 508 includes an electronic circuit specific to a standard that enables wired or wireless communication. The transceiver 508 is configured to communicate internally between internal hardware components of the station 302 and with external devices via one or more networks.

In an embodiment herein, the data driven model-based AP classifying controller 504 is a part of the processor 502, where the data driven model-based AP classifying controller 504 communicates with the AP 304 through the transceiver 508. In an embodiment, the data driven model-based AP classifying controller 504 may be outside the processor 502 but the data driven model-based AP classifying controller 504 is in communication with the processor 502, where the data driven model-based AP classifying controller 504 communicates with the AP 304 through the transceiver 508. In an embodiment herein, the data driven model-based AP classifying controller 504 is outside the processor 502, and the data driven model-based AP classifying controller 504 works separately from the processor 502, where the data driven model-based AP classifying controller 504 communicates with the AP 304 through the transceiver 508.

The memory 506 stores instructions to be executed by the processor 102. The memory 506 may include non-volatile storage elements. Examples of such non-volatile storage elements may include magnetic hard discs, optical discs, floppy discs, flash memories, or forms of electrically programmable memories (EPROM) or electrically erasable and programmable memories (EEPROM). In addition, the memory 506 may, in some examples, be considered a non-transitory storage medium. The term “non-transitory” may indicate that the storage medium is not embodied in a carrier wave or a propagated signal. However, the term “non-transitory” should not be interpreted that the memory 506 is non-movable. In certain examples, a non-transitory storage medium may store data that can, over time, change (e.g., in random access memory (RAM) or cache).

The one or a plurality of processors 502 control the processing of the input data in accordance with the data driven model 510 having a predefined operating rule or an AI model stored in the non-volatile memory and the volatile memory 506. The predefined operating rule or artificial intelligence model is provided through training or learning.

Being provided through learning may refer, for example, to a predefined operating rule or AI model of a desired characteristic is made by applying a learning algorithm to a plurality of learning data. The learning may be performed in a device itself in which AI according to an embodiment is performed, and may be implemented through a separate server or a system.

The data driven model 510 may comprise of a plurality of neural network layers. Each layer has a plurality of weight values, and performs a layer operation through calculation of a previous layer and an operation of a plurality of weights. Examples of neural networks include, but are not limited to, convolutional neural network (CNN), deep neural network (DNN), recurrent neural network (RNN), restricted Boltzmann Machine (RBM), deep belief network (DBN), bidirectional recurrent deep neural network (BRDNN), generative adversarial networks (GAN), and deep Q-networks.

The learning algorithm may refer, for example, to a method for training a predetermined target device (for example, a robot) using a plurality of learning data to cause, allow, or control the target device to make a determination or prediction. Examples of learning algorithms include, but are not limited to, supervised learning, unsupervised learning, semi-supervised learning, or reinforcement learning.

In various embodiments herein the data driven model-based AP classifying controller 504 may receive at least one signal parameter of the Wi-Fi system 300 by performing a signal scanning of at least one available AP 304 in an area of the station 302. The at least one signal parameter comprises at least one of: a RSSI, a SNR, a vendor element, and a CSI. The signal scanning may be a Wi-Fi signal scanning. The signal scanning comprises at least one of: an active Wi-Fi scanning and a passive Wi-Fi scanning. The active Wi-Fi scanning is performed by the Wi-Fi device (station 302 or AP 304) by actively sending out probe request frames to discover nearby networks, instead of just listening passively. In the passive Wi-Fi scanning is the station 302 or the AP 304 discovers networks by listening for APs' 304 beacon frames without sending the probe requests. The Wi-Fi scanning is performed by at least one of: connecting to the AP and without connecting to the AP in the area of the station.

In an embodiment herein, the data driven model-based AP classifying controller 504 may check the sensor information of the station 302 through the sensor 514. The sensor 514 may include, but is not limited to at least one of: an accelerometer, a gyroscope, and a magnetometer of the station 302. The sensor information is received to determine a mobility status of the station 302.

In an embodiment herein, the data driven model-based AP classifying controller 504 may pre-process the received at least one signal parameter and the sensor information. The data driven model-based AP classifying controller 504 may extract at least one feature of the at least one signal parameter and the sensor information. The at least one feature comprises at least one of: an acceleration magnitude of the station 302, a rotational speed of the station 302, an orientation change of the station 302, and a signal strength of the

AP 304 using the at least one data driven model 510. The at least one extracted feature of the at least one signal parameter and the sensor information is pre-processed to generate vector values for the at least one data driven model 510.

In an embodiment herein, the data driven model-based AP classifying controller 504 analyzes the received at least one signal parameter, the sensor information, and a historical data using the at least one data driven model 510. The analysis includes synchronizing a time-series data from the sensor information and the at least one signal parameter to ensure a correlation between a movement of the station 302 and a network change in the at least one AP using the at least one data driven model 510. The correlation is established using the time of collection of sensor data and the time of collection of signal parameters. The change in values received from the sensor information is analyzed over a period of time using time series analysis by the least one data driven model 510. The change in the values of the signal parameters is analyzed over a period of time using time series analysis by the least one data driven model 510. The time series analysis studies the data points collected or recorded over time, usually at regular intervals for the sensor information and the at least one signal parameter. Patterns such as trends (long-term direction), seasonality (regular repeating cycles), and irregular fluctuations are identified from the time series data. The patterns and trends are analyzed to determine the correlation between a movement of the at least one station 302 and a network change in the at least one AP using the at least one data driven model 510. The data driven model 510 may include a statistical analysis, a rule-based analysis, logical analysis and regression, and machine learning methods to identify trends in the data.

In an embodiment herein, the data driven model-based AP classifying controller 504 may generate at least one composite feature. The at least one composite feature may include at least one combination of the sensor information and the at least one signal parameter using the at least one data driven model 510. The data driven model-based AP classifying controller 504 may then generate at least one temporal feature from the generated composite feature. The at least one temporal feature may include, but is not limited to at least one of: a moving average, a standard deviation, and a trend over time. The moving average is the average of the at least one composite feature may include, but is not limited to at least one past value and moves forward one point at a time, recalculating the average as at least one new value of the composite feature becomes available at a point of time. The standard deviation may include information of a measure of a dispersion of at least one value of the at least one composite feature in a dataset from the average of the at least one value of the composite feature. The trend over time includes a trend analysis and a pattern change in the at least one value of the at least one composite feature in the dataset over a period of time. Here the dataset refers to the data from the sensor information and the at least one signal parameter. The data driven model-based AP classifying controller 504 determines a posterior probability for whether the at least one AP is the at least one of: a static AP and a non-static AP. The posterior probability is determined by processing the at least one temporal feature using the at least one data driven model 510.

In an embodiment herein, the data driven model-based AP classifying controller 504 may determine a mobility status of the AP in the area of the station based on the posterior probability using the at least one data driven model 510. The mobility status may be determined by classifying the at least one AP as the at least one of: the static AP and the non-static AP based on the analysis of the received at least one signal parameter, the sensor information, and a historical data using the at least one data driven model 510.

Consider an example scenario, wherein the scanned APs are classified into mobile hotspots, and Wi-Fi routers. Various embodiments herein create a Neural network model to classify available APs in the Wi-Fi scan list into static APs (nearby Wi-Fi routers) and non-static APs (mobile hotspots and distant routers). The input Features of the model can be, but not limited to, SSID Pattern (whether the SSID resembles a known mobile hotspot pattern), RSSI Variance (higher variance in signal strength for non-static APs), RSSI Mean (lower average signal strength value for non-static APs), availability percentage (frequency of appearance in scans (lower value for non-static APs)), and so on.

In an embodiment herein, the at least one AP may be the static AP when the temporal features do not change much with the time, or the temporal features may have a minimal change in values, that is there may not be much change in the moving average, standard deviation and the trends over time as the AP is still and static at one place. The temporal features generated may be almost constant, then the at least one AP is classified as a static AP.

In an embodiment herein, the at least one AP may be the non-static AP when the temporal features show a significant change with the time. The temporal features may have a significant change in values, that is there may be a continuous change and fluctuation in the moving average, standard deviation shows much dispersed values and the trends over time is increasing, decreasing and fluctuating significantly rather than being constant. The temporal features generated may show significantly fluctuating values, then the at least one AP is classified as the non-static AP.

In an embodiment herein, the identified non-static AP are stored in the database 512. The basic service set identifier (BSSID) unique to the non-static AP having a precise identity (ID) tag is stored in the BSSID database for the non-static AP. The database 512 containing the BSSID of the identified non-static AP is continuously maintained for future use.

In an embodiment herein, the data driven model-based AP classifying controller 504 may store the RSSI for the AP identified as the static AP in a Wi-Fi fingerprinting dataset. The RSSI for the AP identified as non-static AP is excluded from the Wi-Fi fingerprinting dataset. A spatial context of the station 302 is determined with better accuracy of a location of the station 302 by performing a localization based on the Wi-Fi fingerprinting dataset using at least one machine learning model.

In an embodiment herein, the data driven model-based AP classifying controller 504 may perform at least one action on identifying the mobility status of the at least one AP in the area of the station. The at least one may include adjust a ranking of the available AP in the area of the station, optimize multi-link operations, enforce adaptive security, determining a secure connection policy, setting roaming preferences, multi-link (MLO) band, and provide targeted troubleshooting, based on the mobility status of the at least one AP in the area of the station and the spatial context of the station based on the performed localization.

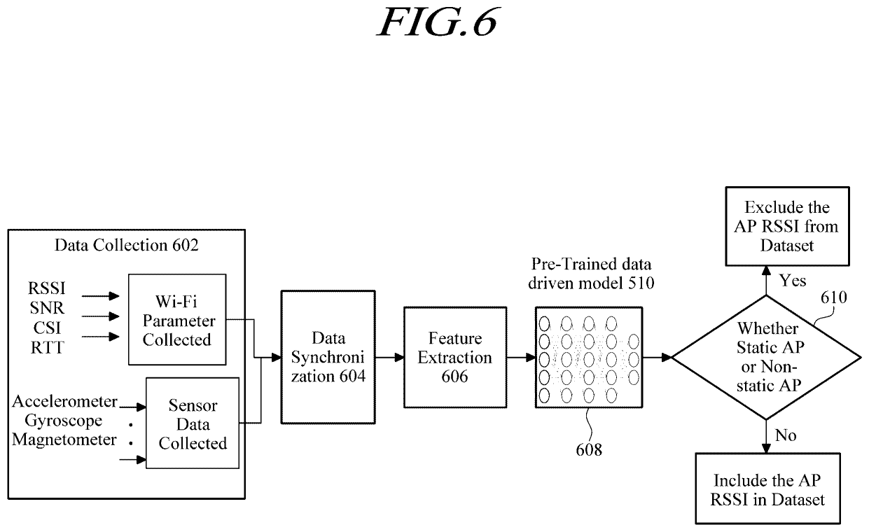

FIG. 6 is a flow diagram 600 illustrating example operations for detection of the non-static AP using the at least one data driven model 510, according to various embodiments. At step 602, the data collection is performed. The sensor information received from one or more sensors from the station 302. The sensor information may be received and collected from the accelerometers, the gyroscopes, and the magnetometers of the station 302 at regular intervals, and the raw sensor information may be pre-processed to extract features such as, but not limited to, an acceleration magnitude, a rotational speed, and an orientation change. The at least one Wi-Fi parameter may be received by the station 302. The Wi-Fi parameters, may include, but is not limited to, RSSI, SNR, CSI, RTT, packet loss rate, and so on. At step 604, data synchronization is performed. The time-series data from the one or more sensors and the Wi-Fi parameters may be synchronized to ensure accurate correlation between the movement of the station 302 and the network changes in the AP 304. At step 606, the composite features from the generated correlation are extracted. The composite features may be generated by combining the sensor information and the at least one Wi-Fi parameter. For example, the correlation between RSSI fluctuations and accelerometer readings are calculated. Further, the one or more temporal features such as, but not limited to, moving averages, standard deviations, and trends over time are extracted. The temporal features are generated using the composite features. At step 608, a neural network integration is performed. The at least one data driven model 510 may process the temporal features and the composite features to determine the mobility status of the AP 304. The at least one data driven model 510 can have inputs for both Wi-Fi parameters and the one or more sensors. At step 610, mobility status may be determined by classifying the at least one AP as the at least one of: the static AP and the non-static AP based on the analysis of the received at least one signal parameter, the sensor information, and a historical data using the at least one data driven model 510.

The various actions in method 600 may be performed in the order presented, in a different order or simultaneously. Further, in various embodiments, some actions listed in FIG. 6 may be omitted.

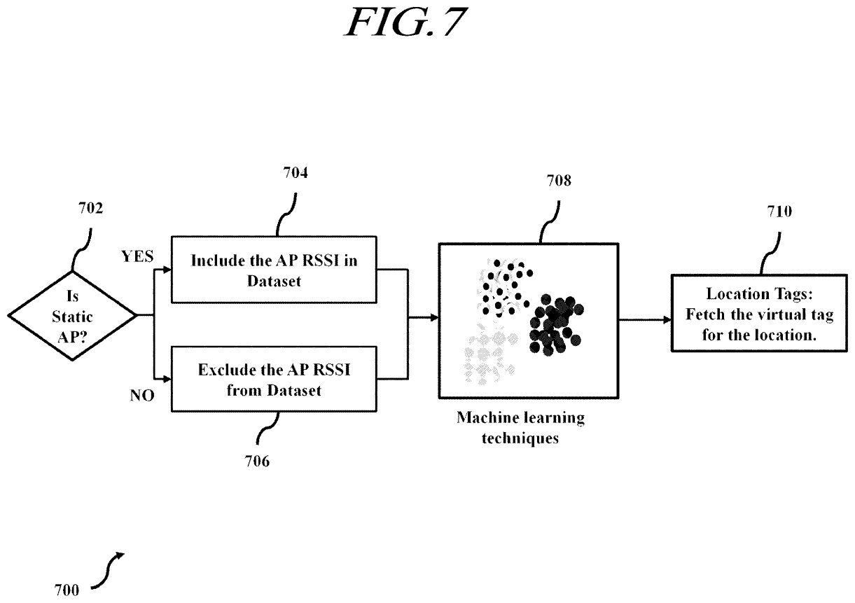

FIG. 7 is a flow diagram 700 illustrating example operations for classifying of the static AP and the non-static AP in the WI-FI RSSI based localization, according to various embodiments. The at least one data driven model 510 may process the temporal features and the composite features to determine the mobility status of the AP 304. At step 702, the mobility status may be determined by classifying the at least one AP as the at least one of: the static AP and the non-static AP based on the analysis of the trends, fluctuation in the moving average and the standard deviation using the at least one data driven model 510. At step 704, if the AP 304 is the static AP, then the data driven model-based AP classifying controller 504 may store the RSSI for the AP identified as the static AP in a Wi-Fi fingerprinting dataset. At step 706, the RSSI for the AP identified as non-static AP is excluded from the Wi-Fi fingerprinting dataset. The Wi-Fi fingerprinting dataset having the RSSI of the static APs may be used to perform localization of the station 302.

In an embodiment herein, for knowing the location of the station 302, embodiments herein create the RSSI vector from a scan list and compare the with the stored RSSI fingerprints in the database 512. The one that matches closely will be the determined location. Various distance metrics can be used to match the RSSI vector with the RSSI fingerprints, such as, but not limited to, Cosine similarity, Manhattan norm (L1 norm), Euclidean norm (L2 norm), and so on.

In an embodiment herein, the data driven model-based AP classifying controller 504 location collects raw data from the one or more sensors and collects the Wi-Fi parameters. The raw data may have labels (A6, A9 etc.) for the location available beforehand. For example, the Wi-Fi RSSI, the Bluetooth signal, the GPS coordinates, and the camera frames with the known ground-truth locations are collected for the AP 304 available in the coverage area of the station 302. At least one relevant feature is extracted from the raw data, for example, average signal strength from multiple APs, angle of arrival, image key points etc. At step 708, various embodiments herein may train a supervised machine learning (ML) model on the labeled dataset. The supervised ML model may be for example k-Nearest Neighbors, Random Forests, Neural Networks, CNNs for performing localization. The model is trained for pattern matching by analyzing the received Wi-Fi parameters with the historical data stored in the database 512. At step 710, the ML model performs the pattern matching using the RSSI Wi-Fi fingerprinting dataset. The localization is user-specific and personalized. In this case, the fingerprint database needs to be built/updated as the user keeps visiting new locations, and there are no named labels available (not required in most cases).

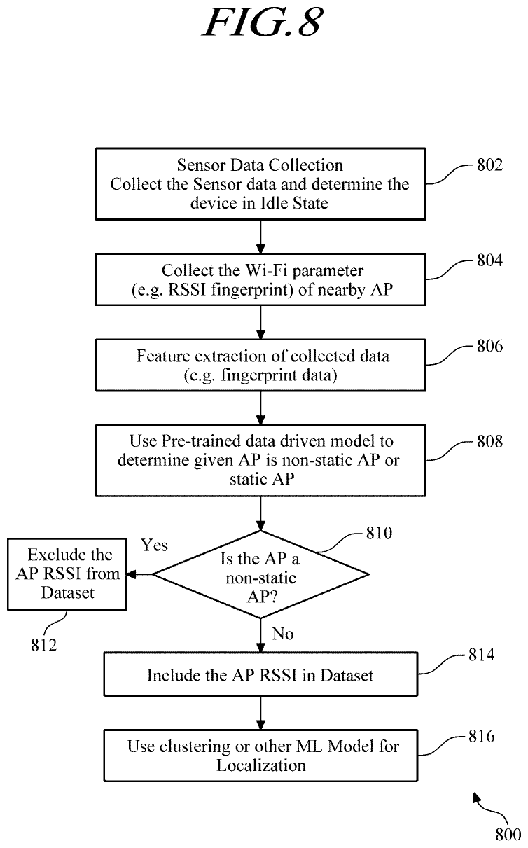

FIG. 8 is a flowchart 800 illustrating an example method for optimizing Wi-Fi RSSI fingerprint database with Static and Non-static AP classification according to various embodiments. At step 802, the data driven model-based AP classifying controller 504 receives the sensor information from the station 302 through the sensor 514. The sensor 514 may include, but is not limited to at least one of: the accelerometer, the gyroscope, and the magnetometer. At step 804, the data driven model-based AP classifying controller 504 may receive the at least one signal parameter of the Wi-Fi system 300 by performing the signal scanning of at least one available AP 304 in an area of the station 302. At step 806, the data driven model-based AP classifying controller 504 may pre-process the received at least one signal parameter and the sensor information. The data driven model-based AP classifying controller 504 may extract at least one feature of the at least one signal parameter and the sensor information. The at least one feature comprises at least one of: an acceleration magnitude of the AP 304, a rotational speed of the AP 304, an orientation change of the AP 304, and a signal strength of the AP 304 using the at least one data driven model 510. The data driven model-based AP classifying controller 504 analyzes the received at least one signal parameter, the sensor information, and a historical data using the at least one data driven model 510. The data driven model-based AP classifying controller 504 generates composite features and the temporal features from the pre-processed extracted features. At step 808. the data driven model-based AP classifying controller 504 may determine the mobility status of the AP in the area of the station based on the posterior probability using the at least one data driven model 510. The mobility status may be determined by classifying the at least one AP as the at least one of: the static AP and the non-static AP based on the analysis of the received at least one signal parameter, the sensor information, and the historical data using the at least one data driven model 510. At step 810, the data driven model-based AP classifying controller 504 checks whether the mobility status of the AP is determined as the at least one of: the static AP and the non-static AP. At step 812, in case when the mobility status of the AP is determined as the non-static AP, the RSSI of the non-static AP is excluded from the Wi-Fi fingerprint dataset in the database 512. At step 814, in case when the mobility status of the AP is determined as the static AP, the RSSI of the static AP is included in the Wi-Fi fingerprint dataset in the database 512. At step 816, the Wi-Fi fingerprinting dataset having the RSSI of the static APs may be used to perform localization of the station 302 using the machine learning model. The ML model is trained for pattern matching by analyzing the received Wi-Fi parameters with the historical data stored in the database 512. The model performs the pattern matching using the RSSI Wi-Fi fingerprinting dataset.

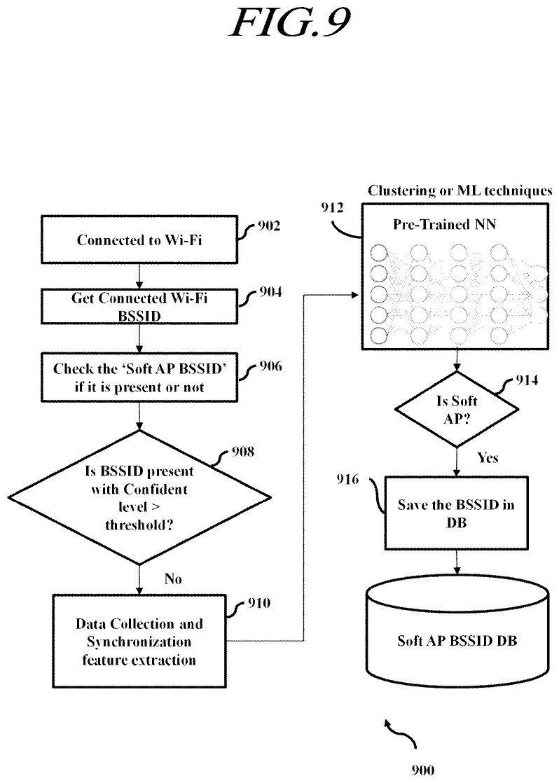

FIG. 9 is a flowchart 900 illustrating an example method for using a pre-saved mobility status information to determine the mobility status of the AP 304, according to various embodiments. At step 902, the station 302 may connect to a nearby available AP 304. At step 904, the station 302 gets connected to the BSSID of the AP 304. At step 906, the data driven model-based AP classifying controller 504 checks whether the BSSID of the AP 304 to which the station 302 is connected to is present in the database 512 for the non-static AP. At step 908, the data driven model-based AP classifying controller 504 checks the BSSID of the AP 304 with a confidence level is not present in the database 512. At step 910, the station 302 performs the data collection 602, the data synchronization 604, and the feature extraction 606 for the AP 304 to which the station 302 is connected. At step 912, the extracted features are provided to the data driven model 510 for analysis. At step 914, the data driven model 510 determines whether the AP 304 is the static AP or the non-static AP. At step 916, if the AP 304 is classified as no-static AP, the data driven model-based AP classifying controller 504 saves the BSSID of the non-static AP in the non-static AP BSSID database in the database 512.

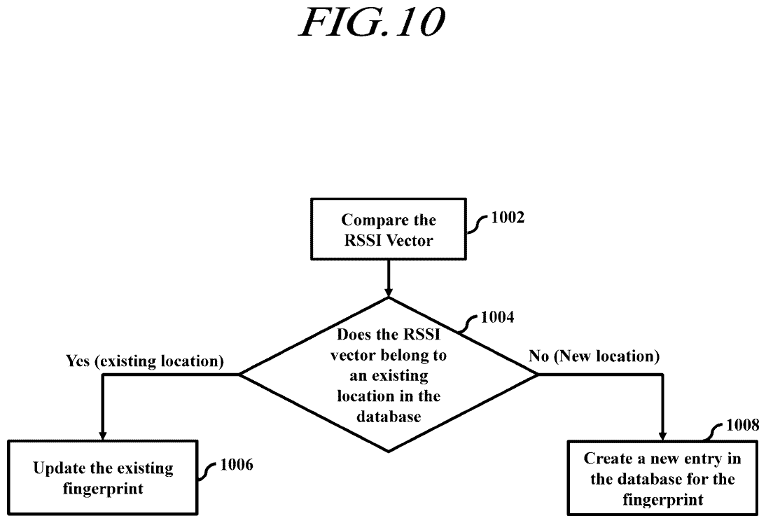

FIG. 10 is a flow diagram 1000 illustrating an example process of separating a new location from an existing location, according to various embodiments. Embodiments herein may use unsupervised learning, as unlabeled data is being handled; e.g., embodiments herein can use clustering to group the RSSI data. The RSSI vectors in a single cluster belong to one location and the number of clusters determines the number of unique locations. At step 1002, the RSSI vectors are compared to determine whether the RSSI vector is already existing in the database or not. At step 1004, the comparison is performed and it is determined whether the RSSI vector is already existing in the database or not. At step 1006, if the RSSI vector is found in the database, the RSSI fingerprint is updated in the database. At step 1008, if the RSSI vector is not present in the database, the RSSI is added in a new location in the database.

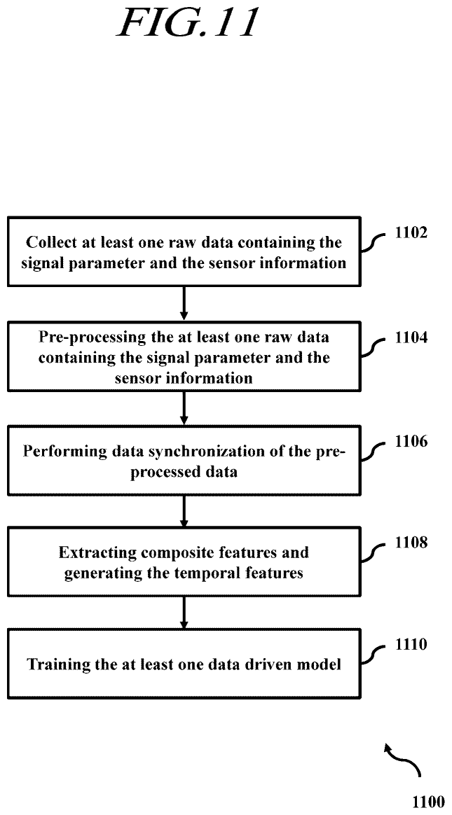

FIG. 11 is a flowchart 1100 illustrating example operations to train the data driven model 510, according to various embodiments. At step 1102, the data driven model-based AP classifying controller 504 may collect the at least one signal parameter and the sensor information of the Wi-Fi system under at least one movement scenario by the signal scanning as a training data. At step 1104, the at least one signal parameter and the sensor information of the Wi-Fi system is pre-processed by the data driven model-based AP classifying controller 504. At step 1106, the pre-processed at least one signal parameter and the sensor information is synchronized and given for feature extraction. At step 1108, the composite features and the temporal features are generated from the correlation of the at least one signal parameter and the sensor information. At step 1110, at least one data driven model 510 is trained by the extracted features and the temporal features to identify the AP as at least one of: the static AP and the non-static based on the collected data from the signal scanning. The at least one data driven model 510 learns from patterns of the historical data and improves with usage from a signal parameter pattern, a plurality of movement scenarios of the at least one AP, and a trend of the collected data in a period of time, making identifying of the AP more relevant over the period of time. An example of training of the data driven model 510 is explained in FIG. 11.

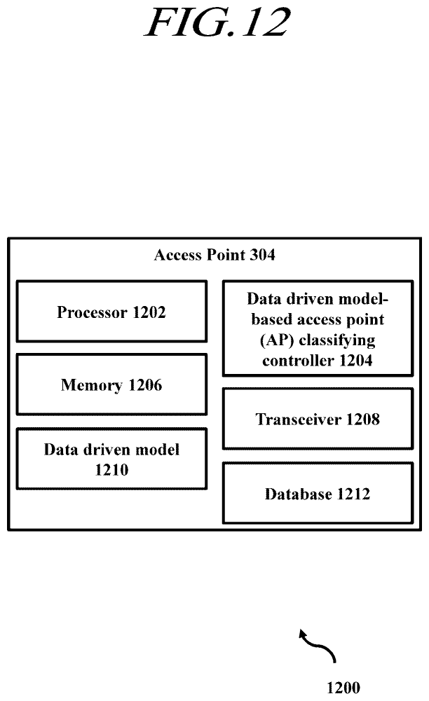

FIG. 12 is a block diagram 1200 illustrating an example configuration of the access point 304, according to various embodiments. The AP 304 includes a processor (e.g., including processing circuitry) 1202, a data driven model-based AP classifying controller (e.g., including various circuitry and/or executable program instructions) 1204, a memory 1206, a transceiver 1208, a data driven model (e.g., including various circuitry and/or executable program instructions) 1210, and a database 1212. The AP 304 may, for example, include a Wi-Fi access point.

The processor 1202, the data driven model-based AP classifying controller 1204, the memory 1206, the transceiver 1208, the data driven model 1210, and the database 1212 communicate with each other.

The processor 502 may include various processing circuitry, including one or a plurality of processors. The one or the plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor 1202 may include multiple cores and is configured to execute the instructions stored in the memory 1206. Thus, as noted above, with reference to FIG. 5, each “processor” or “model” herein includes processing circuitry, and/or may include multiple processors. For example, as used herein, including the claims, the term “processor” or “model” may include various processing circuitry, including at least one processor, wherein one or more of at least one processor, individually and/or collectively in a distributed manner, may be configured to perform various functions described herein. As used herein, when “a processor,” “at least one processor,” “a model,” “at least one model,” and “one or more processors” are described as being configured to perform numerous functions, these terms cover various situations, for example and without limitation, in which one processor and/or model performs some of recited functions and another processor(s) and/or model(s) performs other of recited functions, and also situations in which a single processor and/or model may perform all recited functions. Additionally, the at least one processor may include a combination of processors performing various of the recited/disclosed functions, e.g., in a distributed manner. At least one processor may execute program instructions to achieve or perform various functions. Likewise, the at least one model may include a combination of circuitry and/or processors performing various of the recited/disclosed functions, e.g., in a distributed manner. At least one processor and/or model may execute program instructions to achieve or perform various functions.

In an embodiment herein, the processor 1202 is configured to execute instructions stored in the memory 1206 and to perform various processes. The transceiver 1208 is configured for communicating internally between internal hardware components and with external devices via one or more networks. In an embodiment, the transceiver 1208 includes an electronic circuit specific to a standard that enables wired or wireless communication. The transceiver 1208 is configured to communicate internally between internal hardware components of the AP 304 and with external devices such as the station 302 via one or more networks.

In an embodiment herein, the data driven model-based AP classifying controller 1204 may be a part of the processor 1202, where the data driven model-based AP classifying controller 1204 communicates with the AP 304 through the transceiver 1208. In an embodiment herein, the data driven model-based AP classifying controller 1204 is outside the processor 1202 but the data driven model-based AP classifying controller 1204 is in communication with the processor 1202, where the data driven model-based AP classifying controller 1204 communicates with the AP 304 through the transceiver 1208. In an embodiment herein, the data driven model-based AP classifying controller 1204 is outside the processor 1202, and the data driven model-based AP classifying controller 1204 works separately from the processor 1202, where the data driven model-based AP classifying controller 1204 communicates with the AP 304 through the transceiver 1208.

The memory 1206 stores instructions to be executed by the processor 102. The memory 1206 may include non-volatile storage elements.

Examples of such non-volatile storage elements may include magnetic hard discs, optical discs, floppy discs, flash memories, or forms of EPROM or EEPROM. In addition, the memory 1206 may, in some examples, be considered a non-transitory storage medium. The term “non-transitory” may indicate that the storage medium is not embodied in a carrier wave or a propagated signal. However, the term “non-transitory” should not be interpreted that the memory 1206 is non-movable. In certain examples, a non-transitory storage medium may store data that can, over time, change (e.g., in RAM or cache).

The one or a plurality of processors 1202 control the processing of the input data in accordance with the data driven model 1210 having a predefined operating rule or an AI model stored in the non-volatile memory and the volatile memory 1206. The predefined operating rule or artificial intelligence model is provided through training or learning.

In an embodiment herein, the AP 304 may receive a request to generate a “Neighbor Report” from the station 302. The “Neighbor Report” request is sent from a client device (the station 302 in this case) to the AP 304. The AP 304 may perform the signal scanning of at least one available AP 304 in an area of the station 302. The AP 302 may receive the at least one signal parameter of the Wi-Fi system by performing a signal scanning of at least one available AP 304 in an area of a station 302. The at least one signal parameter comprises at least one of: a RSSI, a SNR, a vendor element, and a CSI. The signal scanning may be a Wi-Fi signal scanning. The signal scanning comprises at least one of: an active Wi-Fi scanning and a passive Wi-Fi scanning. In the neighbor report, the AP 304 uses the signal parameters of the nearby APs to classify the AP 304 into static AP or Non-Static AP. The neighborhood report includes the one-bit information for static AP or Non-Static AP and send to request to the station 302.

In an embodiment herein, the data driven model-based AP classifying controller 1204 may pre-process the received at least one signal parameter. The data driven model-based AP classifying controller 1204 may extract at least one feature of the at least one signal parameter. The at least one feature comprises at least one of: an acceleration magnitude of the station 302, a rotational speed of the station 302, an orientation change of the station 302, and a signal strength of the AP 304 using the at least one data driven model 1210. The at least one extracted feature of the at least one signal parameter and the sensor information is pre-processed to generate vector values for the at least one data driven model 1210.

In an embodiment herein, the data driven model-based AP classifying controller 1204 analyzes the received at least one signal parameter and a historical data using the at least one data driven model 1210. The analysis includes synchronizing a time-series data from the sensor information and the at least one signal parameter to ensure a correlation between a movement of the station 302 and a network change in the at least one AP using the at least one data driven model 1210. The patterns and trends are analyzed to determine the correlation between the movement of the station and a network change in the at least one AP using the at least one data driven model 1210. The data driven model 1210 may include a statistical analysis, a rule-based analysis, logical analysis and regression, and machine learning methods to identify trends in the data.

In an embodiment herein, the data driven model-based AP classifying controller 504 may generate at least one composite feature. The at least one composite feature may include at least one combination of the sensor information and the at least one signal parameter using the at least one data driven model 1210. The data driven model-based AP classifying controller 1204 may then generate at least one temporal feature from the generated composite feature. The at least one temporal feature may include, but is not limited to at least one of: a moving average, a standard deviation, and a trend over time.

In an embodiment herein, the data driven model-based AP classifying controller 1204 may identify the at least one AP 304 as the at least one of: the static AP and the non-static AP based on the analysis of the received at least one signal parameter, the sensor information, and a historical data using the at least one data driven model 1210.

In an embodiment herein, the at least one AP 304 may be the static AP when the temporal features do not change much with the time, or the temporal features may have a minimal change in values, that is there may not be much change in the moving average, standard deviation and the trends over time as the AP is still and static at one place. The temporal features generated may be almost constant, then the at least one AP is classified as a static AP.

In an embodiment herein, the at least one AP 304 may be the non-static AP when the temporal features show a significant change with the time. The temporal features may have a significant change in values, that is there may be a continuous change and fluctuation in the moving average, standard deviation shows much dispersed values and the trends over time is increasing, decreasing and fluctuating significantly rather than being constant. The temporal features generated may show significantly fluctuating values, then the at least one AP is classified as the non-static AP.

Consider an example scenario, wherein the scanned APs are classified into mobile hotspots, and Wi-Fi routers. Embodiments herein create a Neural network model to classify available APs in the Wi-Fi scan list into static APs (nearby Wi-Fi routers) and non-static APs (mobile hotspots and distant routers). The input Features of the model can be, but not limited to, SSID Pattern (whether the SSID resembles a known mobile hotspot pattern), RSSI Variance (higher variance in signal strength for non-static APs), RSSI Mean (lower average signal strength value for non-static APs), availability percentage (frequency of appearance in scans (lower value for non-static APs)), and so on.

In an embodiment herein, the AP 304 may generate a neighbor report by embedding a one-bit mobility indicator, allowing the AP to inform the station whether the at least one AP 304 is at least one of: the static AP and the non-static AP. As the AP 304 is able to determine whether current AP is the static AP or the non-static AP included the 1-bit information helps the station 302 to take better decision to connect to neighboring APs 304.

The AP 304 may return the “Neighbor Report” containing the one-bit information about neighboring APs that are known candidates for the station 302 to reassociate or connect with (should the client choose to do so). Therefore, the Neighbor Report request and the Neighbor Report pair enables the station 302 to collect the information about the neighboring APs of the AP 304 to which the station 302 is currently associated with. The information may be used as identification of potential candidates or APs 304 for a new point of connection or association while roaming.

TABLE 1

| byte | function | value | description |
|---|---|---|---|
| 1 | Element ID | fixed | identifies Neighbor Report IE |
| 2 | length | variable | depends on the number and length of |
| | | | optional sub-elements, minimum = 13 |
| | | | (decimal) if no optional sub-elements are |
| | | | present |
| 3-8 | BSSID | variable | MAC address of AP client is being |
| | | | advised to associate to |
| 9-12 | BSSID | variable | includes reachability of AP, security, |
| | Information | | capabilities of AP, mobility domain of the |
| | | | AP indicated by this BSSID |
| 13 | Operating | variable | Operating Class indicates the channel set |
| | Class | | of the AP indicated by this BSSID |
| | | | Country, Operating Class, and Channel |
| | | | Number together specify the channel |
| | | | frequency and spacing for the AP |
| | | | indicated by this BSSID. |
| 14 | Channel | variable | Channel Number indicates the last known |
| | Number | | operating channel of the AP indicated by |
| | | | this BSSID. |
| 15 | PHY Type | variable | The PHY Type field indicates the PHY |
| | | | type of the AP indicated by this BSSID. |
| 16- | Optional Sub | variable | |
| | elements | | |
| 17 | Mobility | variable | one bit (1 = not-static, 0 - static) |
| | indicator | | |

Table 1 shows the information that may be embedded in the neighbor report generated by the AP 304. The one-bit information about the static AP and the non-static AP is carried in the neighborhood report. The neighbor report comprises at least one information about neighboring APs that are known candidates for the non-AP station to reassociate with. The neighbor report may include a reachability of the AP, a security information, at least one capability of the AP, a mobility domain of the AP indicated by the one-bit mobility indicator.

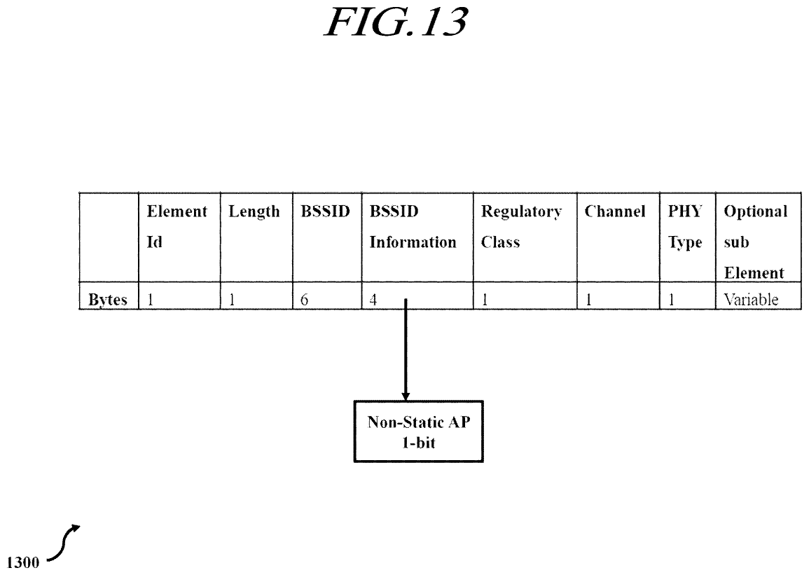

FIG. 13 is a table 1300 illustrating embedding of the one-bit mobility indicator including one bit mobility indicator in neighborhood report in 802.11k, according to various embodiments. The table shows the placement of the one-bit mobility indicator in neighborhood report in 802.11k allowing the AP 304 to inform the station whether the at least one AP 304 is at least one of: the static AP and the non-static AP.

In an embodiment herein, the generated neighbor report is an extension of the 802.11k neighborhood report protocol. The 802.11k neighborhood report protocol helps the station 302 discover neighboring APs, reducing the need for the client to perform off-channel scanning as the station 302 makes the decision on the next Access Point to roam to.

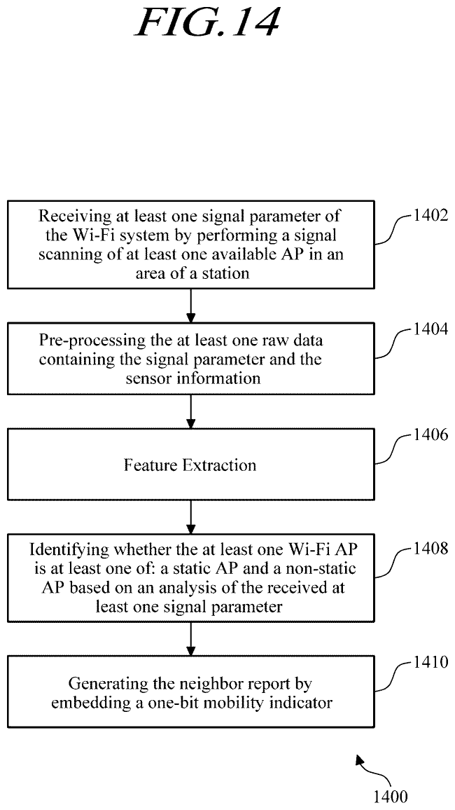

FIG. 14 is a flowchart 1400 illustrating an example method for classifying AP, according to various embodiments. At step 1402, the AP 304 receives at least one signal parameter of the Wi-Fi system by performing the signal scanning of the at least one available AP 304 in an area of the station 302. The AP 304 may receive the “Neighbor Report” request from the station 302. The AP 304 may perform the signal scanning of at least one available AP 304 in an area of the station 302 to receive the at least one signal parameter. At step 1404, the AP 304 pre-processes the received at least one signal parameter and the sensor information. At step 1406, the pre-processed data is then analyzed by data synchronization 604 and feature extraction. The extracted features are analyzed. At step 1408, the AP 304 identifies whether the at least one Wi-Fi AP is at least one of: the static AP and the non-static AP based on an analysis of the received at least one signal parameter, the sensor information, and the historical data using the at least one data driven model 1210. At step 1410, the AP 304 generates the neighbor report by embedding a one-bit mobility indicator, allowing the AP 304 to inform the station whether the at least one AP 304 is at least one of: a static AP and a non-static AP.

Embodiments herein provide one or more Wi-Fi tips to the user at the client side, to help to rectify cause of the issue for its Wi-Fi Connection. In an example herein, Wi-Fi tips may be provided to the user to help to rectify cause of the issue for its Wi-Fi Connection according to the mobility status, that is if the Wi-Fi is the non-static AP or the static AP.

Example Wi-Fi connection troubleshooting tips are listed below in Table 2.

TABLE 2

| Hotspot Problem | Tips |
|---|---|
| Internet is not | Check Data limit reached |
| available | Check Time limit reached |
| | Check if internet is paused by hotspot user |
| | Check if Hotspot Mobile data is enabled |
| | In case of Wi-Fi Sharing, check backhaul Wi-Fi has |
| | internet. |
| | If RSSI is bad suggest user to go near hotspot |
| | device. |
| | Restart the hotspot again |
| Connection failed | Check if Hotspot does not reach max connected |
| | Client. |
| | Restart the Hotspot again. |
| | Check the password type is correct or not. |
| | May be you are connected by OTP last time please |
| | check the password again to connect |
| | If RSSI is bad suggest user to go near hotspot |
| | device. |
| Couldn't reconnect | Suggest user to enable auto reconnect option. |
| | If RSSI is bad suggest user to go near hotspot |
| | device. |
| Incorrect | If user was previously connected then we can |
| Password | suggest that ‘May be you are connected by OTP |
| | last time please check the password again to |
| | connect’. |
| Auto Hotspot | Suggest User possible reason for Auto Hotspot |
| Connection failed | Failed connection. |
| | BLE Failure due to dense BLE device nearby. |
| | Check if Auto Hotspot device is sync with Samsung |
| | account or family account is sync. |

Example use cases for the classification of the AP are as below:

### a) Optimized Link Aggregation:

Prioritization of Links: When connected to the mobile hotspot, the station 302 can prioritize more stable and higher-capacity links. For example, the station 302 might use 5 GHz or 6 GHz bands more selectively to ensure consistent performance without overwhelming the mobile hotspot's limited capacity.
Selective Link Activation: The station 302 can choose to activate fewer links or less demanding links when connected to a mobile hotspot to conserve the hotspot's bandwidth and battery life, while the station 302 might fully utilize all available links when connected to the static AP 304.

### b) Enhanced Power Management:

Adaptive Power Usage: Knowing the station 302 is connected to a mobile hotspot, the station 302 can reduce its power usage by minimizing/reducing the use of high-power links. This helps in prolonging the battery life of both the station and the mobile hotspot.
Link Power Adjustment: The station 302 can dynamically adjust the power of each active link based on the type of connection, using lower power settings for mobile hotspots.

### c) Improved Network Efficiency:

Dynamic Bandwidth Allocation: The station 302 can allocate bandwidth more efficiently based on the type of AP 304. For instance, it may reduce the bandwidth usage on less critical links when connected to a mobile hotspot to avoid congestion and preserve data.
Load Balancing: The device can implement smarter load balancing strategies by shifting less critical data to more stable, the static AP connections and reserving critical, real-time data for mobile hotspots to ensure quality.
Faster Switching: The station 302 can take faster decision from switching from the non-static AP to Available static AP for seamless connection.

### d) 4. Enhanced Security Protocols:

Security Adjustments: When connected to the mobile hotspot, the station 302 can enforce stricter security measures, such as using additional encryption layers or more frequent key exchanges, due to the generally higher risk associated with mobile hotspots.
Alert Mechanisms: The station 302 can alert users about potential security vulnerabilities when connected to a mobile hotspot and suggest switching to the static AP for more secure operations.

### e) Application and Task Prioritization:

Quality of Service (QoS) Adjustments: The station 302 can dynamically adjust QoS settings based on the connection type. For mobile hotspots, the station 302 can prioritize essential applications (e.g., VoIP, video calls) and delay non-critical tasks (e.g., software updates).
Adaptive Streaming Quality: For streaming services, the station 302 can adjust the quality of video or audio streams based on the connection type, reducing the quality when on a mobile hotspot to save bandwidth and ensure smoother playback

The various example embodiments disclosed herein can be implemented through at least one software program running on at least one hardware device and performing network management functions to control the network elements. The elements include blocks which can be at least one of a hardware device, or a combination of hardware device and software module.

The various example embodiments disclosed herein describe a systems and methods for classifying an AP in a Wi-Fi system. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in at least one embodiment through or together with a software program written in e.g., Very high-speed integrated circuit Hardware Description Language (VHDL) another programming language, or implemented by one or more VHDL or several software modules being executed on at least one hardware device. The hardware device can be any kind of portable device that can be programmed. The device may also include means which could be e.g., hardware means like e.g., an ASIC, or a combination of hardware and software means, e.g., an ASIC and an FPGA, or at least one microprocessor and at least one memory with software modules located therein. The method embodiments described herein could be implemented partly in hardware and partly in software. The disclosure may be implemented on different hardware devices, e.g., using a plurality of CPUs. [If this para is not applicable, remove it]

While the disclosure has been illustrated and described with reference to various example embodiments, it will be understood that the various example embodiments are intended to be illustrative, not limiting. It will be further understood by those skilled in the art that various modifications, alternatives and/or variations of the various example embodiments may be made without departing from the true technical spirit and full technical scope of the disclosure, including the appended claims and their equivalents. It will also be understood that any of the embodiment(s) described herein may be used in conjunction with any other embodiment(s) described herein.

What is claimed is:

1. A method for classifying an access point (AP) in a wireless fidelity (Wi-Fi) system, comprising:
receiving, by a station, at least one signal parameter associated with the Wi-Fi system by performing a signal scanning of at least one available AP in an area of the station;
pre-processing, by the station, the received at least one signal parameter and sensor information; and
determining, by the station, a mobility status of the at least one available AP in the area of the station, wherein the mobility status is determined by classifying the at least one available AP as at least one of: a static AP and a non-static AP based on an analysis of the received at least one signal parameter, the sensor information, and historical data using at least one data driven model.

2. The method as claimed in claim 1, wherein the at least one signal parameter comprises at least one of: a received signal strength indicator (RSSI), a signal-to-noise ratio (SNR), a vendor element, and channel state information (CSI).

3. The method as claimed in claim 1, wherein the signal scanning comprises a Wi-Fi scanning, the Wi-Fi scanning including at least one of: an active Wi-Fi scanning and a passive Wi-Fi scanning, and
wherein the Wi-Fi scanning is performed by at least one of: connecting to the at least one available AP and without connecting to the at least one available AP in the area of the station.

4. The method as claimed in claim 1, wherein the station checks the sensor information of the station through at least one of: an accelerometer, a gyroscope, and a magnetometer, and
wherein the sensor information is checked to determine a mobility scenario of the station.

5. The method as claimed in claim 1, wherein pre-processing the received at least one signal parameter and the sensor information comprises:
extracting, by the station, at least one feature of the received at least one signal parameter and the sensor information, wherein the at least one feature comprises at least one of: an acceleration magnitude of the station, rotational speed of the station, an orientation change of the station, and a signal strength of the at least one available AP using the at least one data driven model; and
pre-processing, by the station, the at least one extracted feature of the received at least one signal parameter and the sensor information.

6. The method as claimed in claim 1, wherein analyzing the received at least one signal parameter and the sensor information comprises:
synchronizing, by the station, a time-series data from the sensor information and the received at least one signal parameter for a correlation between a movement of the station and a network change in the at least one available AP using the at least one data driven model;
generating, by the station, at least one composite feature, wherein the at least one composite feature comprises at least one combination of the sensor information and the received at least one signal parameter using the at least one data driven model;
generating, by the station, at least one temporal feature from the generated at least one composite feature, wherein the at least one temporal feature comprises at least one of: a moving average, a standard deviation, and a trend over time, wherein the moving average is an average of the at least one composite feature comprising at least one past value and moves forward one point at a time, recalculating the average as at least one new value of the at least one composite feature becomes available at a point of time, wherein the standard deviation comprises information of a measure of a dispersion of at least one value of the at least one composite feature in a dataset from the average of the at least one value of the at least one composite feature, and wherein a trend over time comprises a trend analysis and a pattern change in the at least one value of the at least one composite feature in the dataset over a period of time; and
determining, by the station, a posterior probability for whether the at least one available AP is the at least one of: the static AP and the non-static AP, wherein the posterior probability is determined by processing the at least one temporal feature using the at least one data driven model.

7. The method as claimed in claim 1, wherein further comprising:
storing, by the station, the classified non-static AP in a database; and
maintaining, by the station, the database of the classified non-static AP.

8. The method as claimed in claim 1, wherein further comprising:
storing, by the station, a received signal strength indicator (RSSI) for the classified static AP in a Wi-Fi fingerprinting dataset, wherein a RSSI for the classified non-static AP is excluded from the Wi-Fi fingerprinting dataset; and
determining, by the station, a spatial context of the station by performing a localization based on the Wi-Fi fingerprinting dataset using the at least one machine learning model.

9. The method as claimed in claim 8, wherein further comprising performing, by the station, at least one action on identifying the mobility status of the at least one available AP in the area of the station, wherein the at least one action comprises at least one of: adjust a ranking of the at least one available AP in the area of the station, optimize multi-link operations of the Wi-Fi system, enforce adaptive security, determining a secure connection policy, setting roaming preferences, and provide targeted troubleshooting, based on the mobility status of the at least one available AP in the area of the station and the spatial context of the station based on the performed localization.

10. The method as claimed in claim 1, wherein the at least one data driven model includes a pre-trained data driven model, wherein the pre-training of the at least one data driven model comprises:
collecting, by the station, the received at least one signal parameter and the sensor information of the Wi-Fi system under at least one movement scenario by performing the signal scanning;
pre-processing, by the station, the at least one signal parameter of the Wi-Fi system; and
training, by the station, the at least one data driven model to identify the at least one available AP as at least one of: the static AP and the non-static AP based on the collected at least one signal parameter and the sensor information, wherein the at least one data driven model learns from patterns of the historical data and changes with usage from a signal parameter pattern, a plurality of movement scenarios of the at least one station, and a trend of the collected data in a period of time.

11. The method as claimed in claim 1, wherein the mobility status is used to perform at least one action, and wherein the at least one action comprises at least one guide ranking in a scan list.

12. A method for classifying an access point (AP) in a wireless fidelity (Wi-Fi) system, comprising:
receiving, by an AP, at least one signal parameter of the Wi-Fi system by performing a signal scanning of at least one available AP in an area of a station;
pre-processing, by the AP, the received at least one signal parameter;
identifying, by the AP, whether the at least one available AP is at least one of: a static AP and a non-static AP based on an analysis of the received at least one signal parameter and historical data using at least one data driven model; and
generating, by the AP, a neighbor report including a mobility indicator, the mobility indicator including information to inform the station whether the at least one available AP is at least one of: a static AP and a non-static AP.

13. The method as claimed in claim 12, wherein performing the signal scanning comprises:
receiving, by the AP, a request to generate the neighbor report from the station; and
performing, by the AP, the signal scanning of the at least one available AP in the area of the station.

14. The method as claimed in claim 12, wherein the neighbor report comprises at least one information about neighboring APs that are known candidates for the station to reassociate with, and wherein the neighbor report comprises basic service set identifier (BSSID) information comprising a reachability of the at least one available AP, security information, and at least one capability of the at least one available AP.

15. The method as claimed in claim 14, wherein the BSSID information comprises the mobility indicator indicating whether the at least one available AP is at least one of: the static AP and the non-static AP.

16. The method as claimed in claim 12, wherein the generated neighbor report includes an extension of 802.11k neighborhood report protocol.

17. A station in a wireless fidelity (Wi-Fi) system, comprising:
at least one processor, comprising processing circuitry, individually and/or collectively, configured to execute at least one data driven model;
memory; and
a data driven model-based access point (AP) classifying controller, comprising circuitry, coupled with at least one processor and the memory, configured to cause the station to:
receive at least one signal parameter of the Wi-Fi system by performing a signal scanning of at least one available AP in an area of the station;
pre-process the received at least one signal parameter and sensor information; and
determine a mobility status of the at least one available AP in the area of the station, wherein the mobility status is determined by classifying the at least one available AP as at least one of: a static AP and a non-static AP based on an analysis of the received at least one signal parameter, the sensor information, and historical data using the at least one data driven model.

18. The station as claimed in claim 17, wherein the at least one signal parameter comprises at least one of: a received signal strength indicator (RSSI), a signal-to-noise ratio (SNR), a vendor element, and channel state information (CSI).

19. An access point (AP) in a wireless fidelity (Wi-Fi) system, comprising:
at least one processor, comprising processing circuitry, individually and/or collectively, configured to execute at least one data driven model;
memory; and
a data driven model-based AP classifying controller, comprising circuitry, coupled with at least one processor and the memory, configured to cause the AP to:
receive at least one signal parameter of the Wi-Fi system by performing a signal scanning of at least one available AP in an area of a station;
pre-process the received at least one signal parameter;
identify whether the at least one available AP is at least one of: a static AP and a non-static AP based on an analysis of the received at least one signal parameter and historical data using the at least one data driven model; and
generate a neighbor report including a mobility indicator, the mobility indicator including information to inform the station whether the at least one AP is at least one of: a static AP and a non-static AP.

20. The AP as claimed in claim 19, wherein the data driven model-based AP classifying controller is configured to cause the AP to:
receive a request to generate the neighbor report from the station; and
perform the signal scanning of the at least one available AP in the area of the station.
